(19) United States
(12) Patent Application Publication
(10) Pub. No.: US 2008/0011721 A1
(43) Pub. Date: Jan. 17, 2008

(54) Copper-Plating Free Solid Wire Assembly for Gas-Shielded Arc Welding

(76) Inventor: Byung Ho Park, Gyeongnam (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/775,971

(22) Filed: Jul. 11, 2007

(30) Foreign Application Priority Data
Jul. 13, 2006 (KR) 10-2006-0065670

(51) Int. Cl. B23K 35/02; B23K 9/16

(52) U.S. Cl. 219/74

(57) ABSTRACT

A copper plating-free solid wire assembly for gas-shielded arc welding includes a spool, a contact tip, and a solid wire wound around the spool. The wire is composed of 0.03-0.10 wt % C, 0.45-1.05 wt % Si, 0.90-1.90 wt % Mn, less than 0.030 wt % P, less than 0.030 wt % S, and the remainder including Fe and impurities, and a cast diameter reduction ratio according to consumption of a wire, which is defined by the following equation, is equal to or less than 0.55:

$$Cast - diameter reduction ratio according to wire consumption = \frac{Cf - Co}{Cf}$$

where Cf represents the cast diameter of the wire wound around an upper portion of the spool, and Co represents the cast diameter of the wire wound around a lower portion of the spool.

### CROSS-REFERENCE TO RELATED APPLICATION

The present application claims the benefit under 35 U.S.C. §119 to Korean Patent Application No. 10-2006-0065670, filed Jul. 13, 2006, which is hereby incorporated by reference in its entirety.

### BACKGROUND

1. Field of the Invention

The present invention relates to a solid wire assembly, and more specifically, to a copper plating-free solid wire assembly for gas-shielded arc welding which includes a spool, a contact tip, and a solid wire wound around the spool.

2. Description of the Related Art

In general, a solid wire for gas-shielded arc welding has a diameter of 0.8-1.6 mm and its surface is often plated with copper in order to enhance conductivity and rust resistance. However, when a copper-plated solid wire is used, the copper plating may come off during the welding process due to friction inside a conduit cable. When welding is performed for a long time, dislodged flakes of copper clog the inside of the conduit cable, thereby increasing feeding resistance. This has an adverse effect on wire feeding performance and arc stability. Further, wastewater is generated during the process of plating the wire with copper, which poses an environmental problem and incurs wastewater disposal costs.

Recently, to avoid problems associated with a copper-plated wire, a wire that is not plated with copper is being used more. Such a copper plating-free wire is currently undergoing extensive research. When a copper plating-free wire is used, since no plating process is employed, no wastewater is generated and thus wastewater disposal costs can be saved. Also, flaking of the copper plating due to friction inside a conduit cable during welding is not an issue. However, the copper plating-free wire increases wear of a contact tip, necessitating more frequent contact tip replacement. Therefore, operational efficiency is degraded.

Generally, a welding wire weighing more than 100 kg is wound around a pail pack and a welding wire weighing about 20 kg is wound around a spool. Contact-tip wear testing shows that contact tip wear for the copper plating-free wire wound around the spool is more severe than for the copper plating-free wire around the pail pack.

Patent documents related to methods of reducing contact tip wear during welding will be examined as follows.

In Japanese Unexamined Patent Application Publication No. 2005-074490, the surface roughness Ra of welding wire, lubricant components, and a coated amount are defined, so that wire feeding performance and contact tip wear resistance are improved. However, there is a limit to improving wire feeding performance and contact tip wear resistance during welding by simply defining the surface roughness Ra, lubricant components, and a coated amount. Particularly, there is a limit to reducing contact tip wear for wire wound around a spool.

Further, in Japanese Unexamined Patent Application Publication No. 2003-039191, 0.002-0.3 mg of oxide scales are formed per 100 mm² area on a wire surface, at least one of MoS₂, WS₂ and graphite particles having a size of 0.1-10 μm are coated on the wire surface in an amount of up to 0.01-2 g per 10 kg of wire, and up to 0.2-2.0 g of at least one of plant oil, animal oil, mineral oil, and compound oil is coated on the wire surface to enhance contact tip wear resistance and welding performance. In this technique, however, the oxide film formed on the wire surface is fused at a contact point between the wire and the contact tip, and the fused amount gradually increases when welding is performed for a long time. Therefore, conductivity between the wire and the contact tip and wire feeding performance are degraded.

Further, Japanese Unexamined Patent Application Publication No. 2005-246419 defines the tensile strength of wire, a cast diameter, an actual diameter, and lubricant components, and Japanese Unexamined Patent Application Publication No. 2004-237299 defines wire surface lubricant components.

However, while the disclosed techniques improve feeding performance of a welding wire and contact tip wear resistance, they overlook wire surface roughness which is one of the most important factors for contact tip wear resistance. Thus, they are limited in their capacity to reduce contact tip wear in the case of a wire wound around a spool.

### SUMMARY

An embodiment of the present invention provides a copper plating-free solid wire for gas-shielded arc welding wound around a spool, in which a cast diameter reduction ratio according to consumption of a wire, a worked wire surface ratio, and a variation in worked surface ratio at four points measured along the wire's circumferential direction are maintained within an optimal range such that contact tip wear resistance is enhanced.

Aspects of the invention enable proper selection of a contact tip and a proper contact tip replacement period, when a copper plating-free solid wire for gas-shielded arc welding wound around a spool is used to perform welding.

According to an aspect of the invention, a copper plating-free solid wire assembly for gas-shielded arc welding comprises a spool, a contact tip, and a solid wire wound around the spool. The wire comprises 0.03-0.10 wt % C, 0.45-1.05 wt % Si, 0.90-1.90 wt % Mn, less than 0.030 wt % P, less than 0.030 wt % S, and the remainder comprising Fe and impurities. And, a cast diameter reduction ratio according to consumption of a wire is equal to or less than 0.55.

Preferably, in the finalized wire wound around the spool, a worked surface ratio in an arbitrary 10000 tm² area on the wire surface ranges from 35% to 75%. Further, a variation in worked surface ratio at four points measured along the circumferential direction of the wire is equal to or less than 12.

According to another embodiment of the invention, a welding method using a copper plating-free solid wire assembly for gas-shielded arc welding comprises: selecting a contact tip having a contact-tip contact index of 0.28-0.65, the contact-tip contact index being a relation between a wire through-hole of the contact tip and a contact point of a worked surface on a wire surface; continuously performing welding for one hour while repeating welding and stop until a wire wound around a spool is completely consumed; calculating the cross-sectional area of the contact-tip through-hole during welding and measuring the amount of contact tip wear; and when the cross-sectional area of the contact-tip through-hole exceeds twice the cross-sectional area of the wire, replacing the contact tip.

### BRIEF DESCRIPTION OF THE DRAWINGS

The present invention will be more apparent from the following detailed description taken in conjunction with the accompanying drawings, in which:

FIG. 1 is a cross-sectional view showing a welding wire according to an exemplary embodiment of the invention passing through a contact tip;

FIG. 2 is a side cross-sectional view of a spool around which the welding wire of FIG. 1 is wound, showing the upper, middle, and lower portions of the spool;

FIG. 3 is a perspective view of a vertical and horizontal roller for adjusting a cast diameter of a wire before winding is finally performed;

FIG. 4 is a diagram of a probe and a contact portion on a wire surface when the surface roughness of the wire is measured;

FIG. 5A is an optical microscope photograph of a wire to be measured;

FIG. 5B is a photograph of a worked surface taken using image analyzing equipment;

FIG. 6 is a cross-sectional view of the leading end of a contact tip according to the invention;

FIG. 7 is a perspective view showing welding for a contact-tip wear measurement test.

### DETAILED DESCRIPTION OF EXEMPLARY EMBODIMENTS

Hereinafter, exemplary embodiments of the present invention will be described in detail with reference to the accompanying drawings.

First, the role and amount of each element contained in a finalized solid wire according to an exemplary embodiment of the invention will be described.

C: 0.03-0.10 wt %;

C serves to enhance the strength of welding wire and deposited metal. As the content of C in the wire increases, a spatter quantity increases during welding. When the content is less than 0.03%, the strength of the welding wire and the deposited metal significantly decreases. When the C content exceeds 0.10%, the spatter quantity increases during welding.

Si: 0.45-1.05 wt %;

Si serves to enhance the fluidity of fused metal and to improve the spreading of welding beads. Further, Si is an essential element for ensuring the strength of deposited metal and promotes deoxidation in fused metal such that slag is formed on the deposited metal. When the content of Si is less than 0.45%, the tensile strength of the welding wire and the deposited metal and the fluidity of the fused metal decrease. When the content exceeds 1.05%, while welding is performed using a high current, there is more chance of poor beading. Further, the droplet fluidity increases, and the droplet quivering adversely affects arc stability.

Mn: 0.90-1.90 wt %;

Like Si, Mn serves to promote deoxidation in fused metal such that slag is formed on deposited metal. Further, Mn enhances the strength of welding wire and deposited metal. When the content of Mn is less than 0.90%, the tensile strength of the welding wire and proper surface tension of the deposited metal cannot be secured. When the content exceeds 1.90%, the amount of active oxygen in droplets during welding is reduced, and thus the surface tension of the droplet is increased.

P: 0.030 wt % or less

P exists as impurities in metal. A low melting point compound is formed by P, thereby increasing sensitivity to high-temperature cracks. When the content of P exceeds 0.030%, it causes high-temperature cracks.

S: 0.030 wt % or less

Similar to P, a low melting point compound is formed by S, thereby increasing sensitivity to high-temperature cracks. When the content of S exceeds 0.030%, it causes high-temperature cracks.

Hereinafter, in a solid wire wound around a spool, a cast diameter reduction ratio according to consumption of a wire and a reason for range limitation will be described.

When a wire is wound around a spool or the like, bending stress is applied to the wire such that the wire forms a shape with a constant curvature. The diameter of the shape with a constant curvature is referred to as a wire cast diameter.

In the invention, a cast diameter reduction ratio according to consumption of a wire was derived from factors having an effect upon contact tip wear which occurs when gas-shielded arc welding is performed using a copper plating-free solid wire wound around a spool.

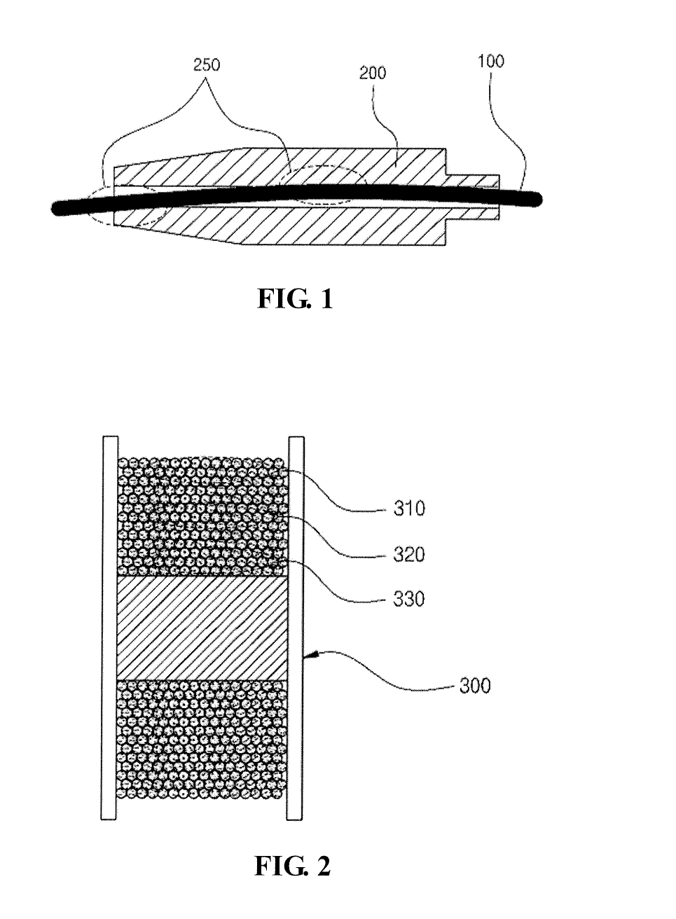

As shown in FIG. 1, when welding is performed, a welding wire wound around a spool passes through a contact tip. Since the welding wire has a cast diameter, contact points 250 are formed inside a contact-tip through-hole, and the contact tip is prone to wear at the contact point of the leading end of the contact tip.

Meanwhile, as shown in FIG. 2, there is a slight difference in cast diameter of a wire depending on a position at which the wire is wound around a spool. That is, the cast diameter of the welding wire differs at the upper portion 310, the middle portion 320, and the lower portion 330 of the spool, respectively. The cast diameter of the welding wire decreases toward the lower portion from the upper portion. In particular, it can be found that the cast diameter of the wire wound around the upper portion of the spool and a difference in cast diameter between the upper and lower portions of the spool are very important factors affecting the wear of the contact tip.

In the invention, “a cast diameter reduction ratio according to consumption of a wire”, which is represented by a ratio of a cast diameter of the wire wound around the upper portion of the spool to a difference in cast diameter between the upper and lower portions of the spool, was derived and defined in the following Equation 1. And, the value of the cast diameter reduction ratio was limited to less than 0.55.

When the cast diameter reduction ratio according to consumption of a wire exceeded 0.55, the difference in cast diameter depending on a position at which the wire is wound around a spool was so large that contact tip wear increased rapidly as welding was performed and the contact tip had to be replaced more frequently. On the contrary, when the cast diameter reduction ratio according to consumption of a wire was equal to or less than 0.55, a constant cast diameter was maintained regardless of a position at which the wire is wound around a spool. Therefore, contact tip wear remains constant and a degree of wear was reduced.

$$Cast - diameter reduction ratio according to wire consumption = \frac{Cf - Co}{Cf} \qquad [ Equation 1 ]$$

Here, Cf represents a cast diameter of a wire wound around the upper portion of a spool, and Co represents a cast diameter of the wire wound around the lower portion of the spool.

Hereinafter, a method of adjusting a cast diameter reduction ratio to less than 0.55 when manufacturing a welding wire will be described.

The cast diameter reduction ratio according to wire consumption is very sensitive to the cast diameter and tensile strength of a wire when the wire is wound around a spool.

As shown in Table 1, when tensile strength is relatively low, that is, when a heat treatment process is included in a manufacturing process, the cast diameter reduction ratio according to wire consumption is small with respect to the cast diameter of the wire when it is wound around a spool. On the contrary, when tensile strength is relatively high, that is, when a heat treatment process is not included in a manufacturing process, the cast diameter reduction ratio according to wire consumption is relatively large with respect to the cast diameter of the wire when it is wound around a spool. Further, the cast diameter reduction ratio according to wire consumption is smaller when the cast diameter of the wire when it is wound around the spool is small than when it is large. Therefore, regardless of whether a heat treatment process is included in a manufacturing process or not, it is preferable that the wire cast diameter at the time of winding the wire around a spool is maintained at less than 700 mm.

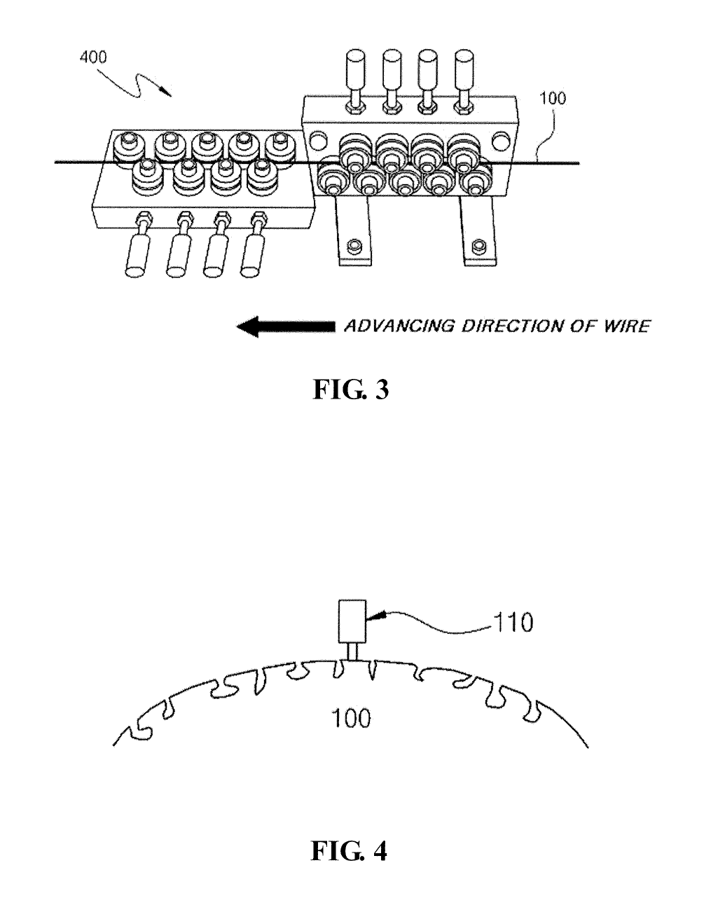

In order to maintain the wire cast diameter at less than 700 mm when the wire is wound around a spool, a vertical and horizontal correction roller 400 is applied before the winding, as shown in FIG. 3. This allows the cast diameter to be adjusted.

TABLE 1

| | | | Cast diameter | Cast diameter | |
|---|---|---|---|---|---|
| | | Cast diameter | (mm) of wire | (mm) of wire | Cast diameter |
| | | (mm) of wire at | wound around | wound around | reduction ratio |
| Application of | Tensile strength of | the time of | upper portion of | lower portion of | according to wire |
| heat treatment | wire (kgf/mm²) | winding | spool (Cf) | spool (Co) | consumption |
| With heat | 115 | 400 | 395 | 330 | 0.16 |
| treatment | | 700 | 660 | 497 | 0.25 |
| | | 1000 | 973 | 582 | 0.40 |
| Without heat | 125 | 400 | 395 | 314 | 0.21 |
| treatment | | 700 | 660 | 423 | 0.36 |
| | | 1000 | 973 | 475 | 0.51 |
| | 130 | 400 | 395 | 311 | 0.21 |
| | | 700 | 660 | 421 | 0.36 |
| | | 1000 | 973 | 430 | 0.56 |

Hereinafter, a reason for range limitation of a worked surface ratio in an arbitrary 10000 μm² area on a wire surface and a variation in worked surface ratio at four points measured along the wire's circumferential direction will be described.

The term “worked surface” refers to a surface leveled by processing of a dice when a drawing process is performed.

The surface roughness of a welding wire is a factor having a large effect on wear resistance of a contact tip during welding. Particularly, a worked wire surface ratio and a variation in worked surface ratio at four points measured along the circumferential direction of the wire are very important factors. In relation to this, an original rod having the same chemical component was used to change a worked surface ratio of a finalized wire while varying a drawing condition and performing or not performing heat treatment. Further, a maintenance range with respect to a worked wire surface ratio was derived, where contact tip wear resistance can be maintained at an optimal state during welding.

Table 2 comparatively shows a worked wire surface ratio according to a method of manufacturing a welding wire and a surface roughness Ra, which is a widely used index for evaluating surface roughness.

As shown in Table 2, even when the same surface roughness Ra was provided, worked surface ratios in an arbitrary 10000 μm² area on a wire surface and variations in worked surface ratio with respect to four surfaces in the circumferential direction of the wire differed from each other. That is, although the values of surface roughness Ra are similar to each other, the surface shapes of wires may differ from each other. This is because there is a limit to discriminating the surfaces of welding wires having a circular cross-section using the surface roughness Ra.

TABLE 2

| | | | Variation in worked surface |
|---|---|---|---|
| | | Worked surface | ration with respect to |
| | Surface | ratio in arbitrary | four surfaces measured |
| | roughness | 10000 μm² area | along the wire's |
| Division | Ra (μm) | on wire surface (%) | circumferential direction |
| 1 | 0.32 | 52.88 | 6.55 |
| 2 | 0.32 | 36.68 | 8.11 |

As shown in FIG. 4, when the surface roughness of wire 100 is represented as the surface roughness Ra, a probe 110 with a minute width should measure a minute region as long as a length measured in the longitudinal direction of the wire at a predetermined position of the wire. Therefore, in order to determine the surface roughness of a wire, the number of measurements should be increased, and variation according to measurement position becomes large.

On the other hand, since the worked wire surface ratio, described herein, indicates a surface state of a wire with respect to a predetermined area on the surface of the wire, the worked surface ratio is more reliable than the surface roughness Ra and is easily measured. Therefore, in order to solve the above-described problem of the surface roughness Ra and to represent a more reliable value of surface roughness, a worked surface ratio in an arbitrary 10000 μm² area on a wire surface and a variation in worked surface ratio at four points measured along the circumferential direction of the wire were applied.

In the invention, it has been found that, when a worked surface ratio in an arbitrary 10000 μm² area on a wire surface has a range of 35 to 75% and a variation in worked surface ratio at four points measured along the circumferential direction of the wire has a range of less than 12, contact tip wear resistance is enhanced.

Hereinafter, a reason why the ranges of a worked surface ratio in an arbitrary 10000 μm² area on a wire surface and a variation in worked surface ratio at four points measured along the circumferential direction of the wire are limited will be described.

When a worked surface ratio in an arbitrary 10000 μm² area on a wire surface is less than 35%, frictional resistance with a contact tip becomes so large that the contact tip is prone to wear. Also, when a worked surface ratio in an arbitrary 10000 μm² area on a wire surface exceeds 75%, a coated amount of coating agent is reduced, and a feeding roller may slip, causing non-uniform wire feeding.

When a variation in worked surface ratio at four points measured along the wire's circumferential direction exceeds 12, frictional resistance with a contact tip is not stable, so that the contact tip is prone to wear.

Hereinafter, a method of measuring the worked wire surface ratio will be described.

The measuring of the worked wire surface ratio was performed while the wire to be measured was observed by an optical microscope and analyzed using Image-Pro Plus Version 5.1 made by Media Cybernetics.

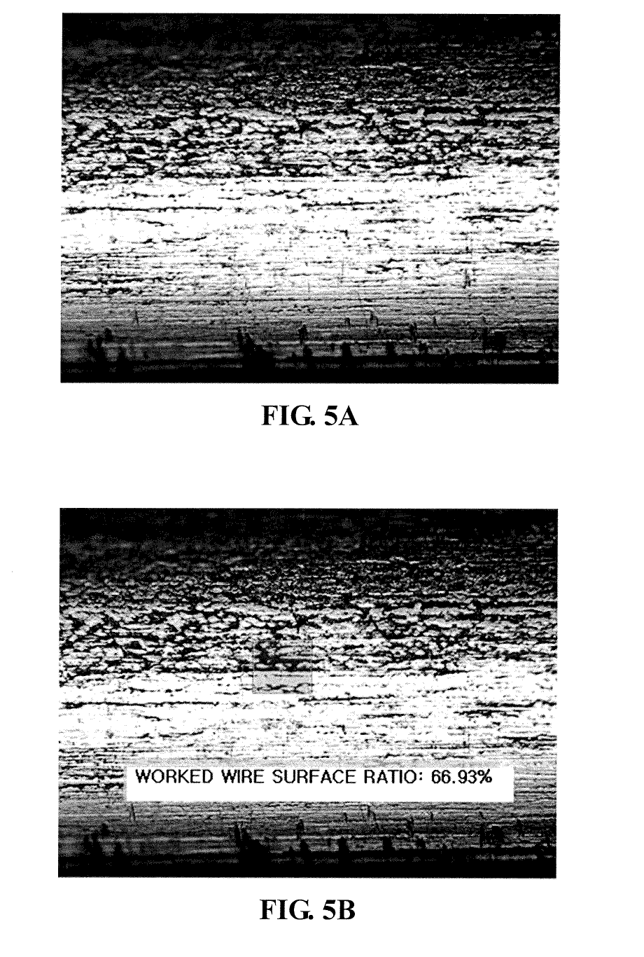

FIGS. 5A and 5B respectively show the optical microscope image of the wire to be measured and the image of the worked surface measured using the image analyzing equipment.

The worked surface on a wire surface is represented as white portions on the optical microscope image of FIG. 5A and refers to portions which are formed by dice processing on a drawing process.

Hereinafter, a worked wire surface ratio at the time of manufacturing a welding wire and a method of controlling a variation in worked surface ratio will be described.

The surface state of a welding wire is largely determined by a drawing process when the wire is manufactured. The drawing process can be performed by applying various schemes. In the invention, however, an in-line drawing method and a two-stage drawing method were applied, in order to secure a worked surface ratio in an arbitrary 10000 μm² area on a wire surface and a variation in worked surface ratio at four points measured along the circumferential direction of the wire. Further, an amount of attached drawing lubricant and the particle size thereof were limited, which are applied on dry drawing and are important factors for controlling a surface state of a wire together with the drawing method.

First, a drawing method which is applied for controlling a surface state of a wire will be described in detail.

All dry drawing (hereinafter, referred to as ‘DD’), dry drawing by all cassette roller die (hereinafter, referred to as ‘CRD’), a one-stage in-line method of dry drawing, or a two-stage drawing method can be applied. In the one-stage in-line drawing method, CRD and DD are combined. In the two-stage drawing method, primary dry drawing is performed using DD or CRD, and secondary wet drawing (hereinafter, referred to as ‘WD’) is then performed. At this time, the dry drawing should be applied as the primary drawing, regardless of the drawing method. After the drawing is completed, a coating agent is coated on the surface of a wire. According to the invention, it is not necessary to include a heat treatment process before and after the drawing process.

Preferably, an attached amount of drawing lubricant, which is used on dry drawing, is maintained in the range of 0.02-0.30 g per 1 kg of wire on the basis of a finalized wire. When an amount of attached drawing lubricant is less than 0.02 g, it is difficult to secure sufficient lubrication on drawing. When an amount of attached drawing lubricant exceeds 0.30 g, the amount of drawing lubricant attached on the surface of a finalized wire is so large that the drawing lubricant attached on the wire surface can drip off or can be clogged within a conduit cable, degrading wire feeding performance and arc stability.

Preferably, among drawing lubricants used on dry drawing, a lubricant having a particle size of more than 500 μm occupies less than 40% of the weight of the total lubricant. When a lubricant having a particle size of more than 500 μm exceeds 40 wt %, a ratio of drawing lubricants having a large particle size is so large that the attachment of drawing lubricant on the surface of wire becomes uneven. Accordingly, lubrication upon drawing is degraded. As a result, the wire surface becomes uneven due to the lack of lubrication upon drawing, thereby increasing variation in worked wire surface ratio.

The amount of attached drawing lubricant for controlling the surface state of a wire was measured by the following method.

1. Cut wire into 6-8 cm pieces ranging in weight from 50 to 80 g.

2. Prepare a beaker containing 1000 ml of CCl₄ as a solvent.

3. Put the prepared wire into the beaker containing CCl₄ and degrease a coating agent for ten minutes while stirring the beaker two or three times.

4. Put the degreased wire into a dry oven to dry the wire for ten minutes and then cool the wire in a desiccator at normal temperature.

5. Put the dried wire onto a 1 g/10000 scale to degrease the wire and then measure the weight Wb of the wire.

6. Dip the prepared wire in 5% chromic trioxide (CrO₃) liquid maintained at 70° C., for 20 minutes.

7. Wash the degreased wire in hot water and then wash the wire with alcohol.

8. Put the wire washed with alcohol into a dry oven to dry the wire for ten minutes and cool the wire in the desiccator at normal temperature.

9. Put the dried wire onto the 1 g/10000 scale to degrease the wire and then measure the weight Wa of the wire.

10. Calculate a residual amount of lubricant using the following equation based on the measured weights Wb and Wa.

Amount of attached drawing lubricant (g/kg wire)={(Wb−Wa)/Wa}×1000

Measuring the particle size of drawing lubricant on dry drawing to control the surface state of the wire was performed by the following method.

1. Put standard sieves in order from 500 μm to 45 μm, up to down.

2. Accurately measure 100 g of drawing lubricant to carry into the 500 μm sieve, put a lid on the sieve, and then shake in a shaker for fifteen minutes.

3. After shaking, brush and collect particles which have not passed through the 500 μm sieve, measure the particles, and calculate the weight percentage (wt%) of particles for each sieve.

Hereinafter, a contact-tip contact index of a wire and a reason for range limitation will be described.

A contact tip refers to a jig which is attached to an end of a welding torch and serves to transmit a welding current to a welding wire during welding and to induce the welding wire into a welding section through a wire through-hole. When the contact tip is worn so as not to perform such functions, defects occur in the welding section. Further, the removal of defects, the replacement of the contact tip and the like degrade welding productivity.

The contact-tip contact index of a wire is a relation between a wire through-hole of a contact tip and a contact point of a worked surface on a wire surface during welding. The contact-tip contact index is an index for selecting a proper contact tip and is defined by the following Equation 2.

$$Contact - tip contact index of wire = \frac{WC}{PC} \times WS \qquad [ Equation 2 ]$$

Here, WC represents the circumference of the wire, PC represents the circumference of a wire through-hole of a contact tip, and WS represents a worked wire surface ratio.

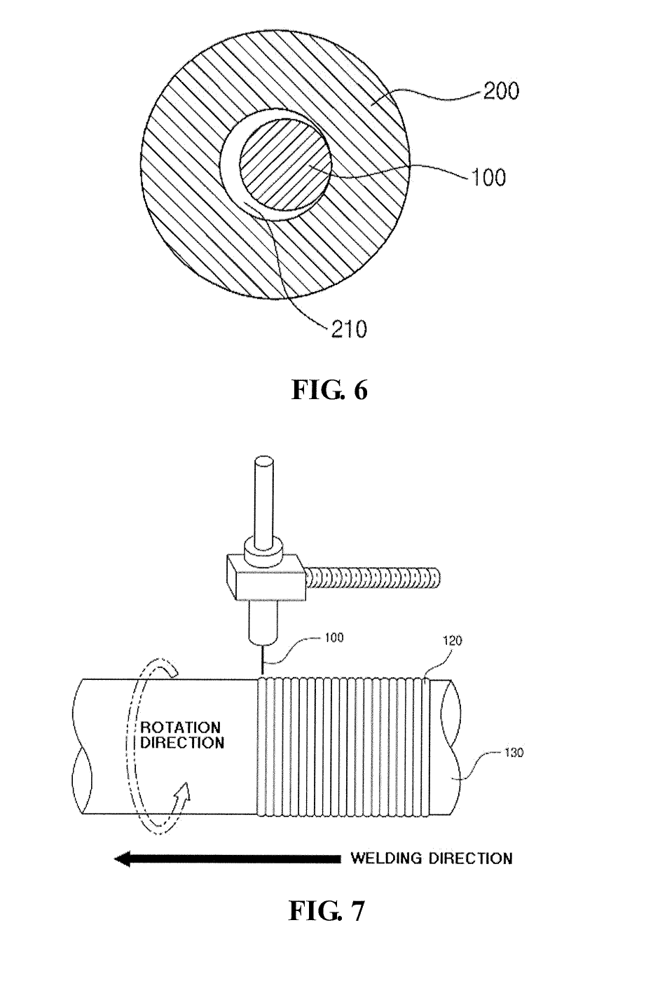

As shown in FIG. 6, a through-hole 210 of a contact tip 200 generally has a larger diameter than a welding wire 100. The reason is that, if the diameter of the through-hole of the contact tip is equal to or smaller than that of the welding wire, frictional resistance significantly increases on feeding such that feeding performance is degraded or feeding is not performed at all. Further, during welding, the surface of the welding wire comes in contact with the inner wall of the contact-tip through-hole. Accordingly, arc is generated at a contact point such that the welding is performed. Further, wear of the contact tip frequently occurs at such a contact point.

Therefore, the contact-tip through-hole and the contact surface with which the welding wire comes in contact are important factors affecting wear of the contact tip. Accordingly, the relationship between the circumference of the contact-tip through-hole and the circumference of wire with respect to a worked wire surface ratio needs to be established.

In the invention, the parameter of Equation 2 for the relationship has been developed and is used as an index for selecting a contact tip. Preferably, the range of the parameter is maintained at 0.28 to 0.65.

Hereinafter, the reason why the range of the contact-tip contact index is limited will be described.

When a contact-tip contact index is less than 0.28, a worked wire surface ratio is so low or the circumference of a contact-tip through-hole is relatively so large that a contact portion between the welding wire and the inner wall of the contact-tip through-hole becomes uneven. Accordingly, arcing between the contact tip and the wire becomes unstable. Further, when the contact-tip contact index exceeds 0.65, the worked wire surface ratio is so high that a feeding roller may slip, causing non-uniform wire feeding.

In the invention, a contact tip replacement period is prescribed. For example, when the cross-sectional area of a through-hole of a contact tip exceeds twice the cross-sectional area of a wire, the contact tip should be replaced.

As welding is continued for a long time, contact tip wear inevitably occurs. As the wear of the contact tip progresses, the wire deviates from a desired welding position. Therefore, when the wear of the contact tip progresses to a certain degree, the contact tip should be replaced. It is very important to properly select the replacement time. Therefore, a contact tip replacement period was represented by a ratio of the cross-sectional area of a contact-tip through-hole and the cross-sectional area of a wire.

The reason for such a range limitation is explained as follows. When the cross-sectional area of a contact-tip through-hole is equal to or less than twice the cross-sectional area of the wire, welding is accurately performed at a welding position desired by a welder. However, when the cross-sectional area of a contact-tip through-hole exceeds twice the cross-sectional are of a wire, welding is performed away from a desired welding position. Therefore, the above-described range needs to be maintained.

Hereinafter, a method of measuring a wear amount of a contact tip will be described.

Table 3 shows chemical components of a welding wire used in the invention. As for the used welding wire, copper plating-free wires for gas-shielded arc welding, which are respectively wound around YGW11 and YGW12 spools, were used.

Table 4 shows welding conditions. As shown in FIG. 7, welding was performed while a steel tube 130 with a length of 800 mm and a thickness of 25 mm was rotated. Particularly, until 20 kg of wire wound around a spool was all consumed, welding was performed on the outside of the steel tube for one hour while ten-minute continuous welding and five-minute stops were repeated. Then, the amount of wear of the contact tip was measured, and the process was repeated.

TABLE 3

| | Wire composition (wt %) | | | | | | |
|---|---|---|---|---|---|---|---|
| Division | C | Si | Mn | P | S | Cu | Ti |
| YGW11 | 0.06 | 0.79 | 1.57 | 0.016 | 0.011 | 0.01 | 0.16 |
| YGW12 | 0.07 | 0.85 | 1.52 | 0.014 | 0.012 | 0.01 | — |

TABLE 4

| Welding conditions | | | Welding position |
|---|---|---|---|
| Welding current 300 A | Welding voltage 32 V | CTWD 20 mm | Flat position |
| Shield gas CO₂ 100% | Gas flow rate 20 l/min | Contact tip CuCr Tip | |

As represented in the following Equation 3, contact tip wear was represented as a ratio of the cross-sectional area of a contact-tip through-hole before welding to the cross-section area of the contact-tip through-hole after welding.

$$Wear amount of contact tip ( \% ) = \frac{( At - Ao )}{Ao} \times 100 \qquad [ Equation 3 ]$$

Here, At represents the cross-sectional area of a contact-tip through-hole after one-hour of welding, and Ao represents the cross-sectional area of the contact-tip through-hole before welding.

The cross-sectional area of the contact-tip through-hole was measured as follows. An image of the contact-tip through-hole was photographed by a microscope and the photographed image was analyzed using Image-Pro Plus Version 5.1 made by Media Cybernetics.

As shown in Table 5, the contact tip wear, obtained by the above-described method, was represented by “⊚” when equal to or less than 35%, by “Δ” when more than 35% and less than 50%, and by “x” when more than 50%.

TABLE 5

| Symbol | Contact tip wear (%) | evaluation |
|---|---|---|
| ∘ | Equal to or less than 35% | Excellent |
| Δ | More than 35% and less than 50% | Normal |
| x | More than 50% | Bad |

Table 6 shows Examples of the invention and Comparative Examples.

TABLE 6

| | | | Drawing lubricant | | | | | | | | | | | |
|---|---|---|---|---|---|---|---|---|---|---|---|---|---|---|
| | | | | Ratio of | | | | Contact-tip contact | | | | | | |
| | | | | lubricant | | Worked | | index of wire | | | Cross-sectional | | | |
| | | | | with | | surface | | | Circum- | | area ratio | | | |
| | | | Attached | particle | Cast | ratio | | Circum- | ference | | Circum- | Cross- | Contact tip | |
| | | | amount | size of | diameter | Area | | ference | of tip | Con- | ference | sectional | wear | |
| | | Drawing | (g/kg | more than | reduction | ratio | Vari- | of wire | before | tact | of tip after | area | Wear | Eval- |
| Division | | method | wire) | 500 μm | ratio | (%) | ation | (mm) | welding | index | welding | ratio | amount | uation |
| Examples | 1 | DD + WD, | 0.20 | 17% | 0.16 | 67.68 | 5.93 | 3.71 | 4.15 | 0.61 | 4.75 | 1.64 | 30.95 | ∘ |
| of the | 2 | CRD + WD | 0.22 | 18% | 0.21 | 69.04 | 3.75 | 3.71 | 4.63 | 0.55 | 5.06 | 1.86 | 19.52 | ∘ |
| | 3 | | 0.27 | 35% | 0.25 | 35.42 | 4.93 | 3.73 | 4.77 | 0.28 | 5.28 | 2.00 | 22.53 | ∘ |
| | 4 | | 0.14 | 9% | 0.25 | 74.87 | 6.93 | 3.71 | 4.64 | 0.60 | 5.07 | 1.87 | 19.39 | ∘ |
| | 5 | | 0.24 | 26% | 0.36 | 44.65 | 11.88 | 3.76 | 4.41 | 0.38 | 5.02 | 1.78 | 29.58 | ∘ |
| | 6 | | 0.18 | 19% | 0.40 | 54.25 | 7.44 | 3.76 | 4.24 | 0.48 | 4.88 | 1.68 | 32.47 | ∘ |
| | 7 | | 0.12 | 12% | 0.51 | 72.43 | 2.75 | 3.76 | 4.18 | 0.65 | 4.85 | 1.66 | 34.63 | ∘ |
| | 8 | DD, | 0.24 | 23% | 0.16 | 52.88 | 6.55 | 3.73 | 4.34 | 0.45 | 5.02 | 1.81 | 33.36 | ∘ |
| | 9 | CRD, | 0.26 | 34% | 0.21 | 35.57 | 5.11 | 3.72 | 4.41 | 0.30 | 5.10 | 1.88 | 33.74 | ∘ |
| | 10 | DD + CRD | 0.23 | 27% | 0.25 | 42.03 | 4.89 | 3.72 | 4.18 | 0.37 | 4.82 | 1.68 | 32.99 | ∘ |
| | 11 | | 0.21 | 21% | 0.36 | 52.88 | 6.55 | 3.73 | 4.76 | 0.41 | 5.22 | 1.96 | 20.27 | ∘ |
| | 12 | | 0.23 | 14% | 0.40 | 71.42 | 7.38 | 3.73 | 4.55 | 0.59 | 5.11 | 1.88 | 26.13 | ∘ |
| | 13 | | 0.13 | 12% | 0.40 | 73.22 | 9.45 | 3.73 | 4.35 | 0.63 | 5.04 | 1.83 | 34.24 | ∘ |
| | 14 | | 0.15 | 15% | 0.51 | 66.48 | 10.90 | 3.72 | 4.26 | 0.58 | 4.92 | 1.75 | 33.39 | ∘ |
| Compar- | 15 | DD + WD, | 0.32 | 41% | 0.16 | 34.72 | 15.12 | 3.73 | 4.25 | 0.30 | 5.66 | 2.30 | 77.36 | x |
| ative | 16 | CRD + WD | 0.34 | 43% | 0.21 | 62.31 | 13.06 | 3.71 | 4.33 | 0.53 | 5.21 | 1.97 | 44.78 | Δ |
| examples | 17 | | 0.31 | 46% | 0.25 | 44.13 | 12.25 | 3.73 | 4.19 | 0.39 | 5.25 | 1.98 | 56.94 | x |
| | 18 | | 0.01 | 16% | 0.36 | 77.16 | 7.89 | 3.71 | 4.35 | 0.66 | 5.67 | 2.33 | 69.68 | x |
| | 19 | | 0.34 | 51% | 0.40 | 33.22 | 12.01 | 3.71 | 4.17 | 0.30 | 5.04 | 1.85 | 46.28 | Δ |
| | 20 | | 0.39 | 48% | 0.51 | 34.13 | 14.44 | 3.71 | 4.91 | 0.26 | 5.79 | 2.44 | 39.06 | Δ |
| | 21 | | 0.32 | 41% | 0.57 | 49.70 | 16.72 | 3.73 | 4.88 | 0.38 | 5.79 | 2.41 | 40.77 | Δ |
| | 22 | | 0.33 | 50% | 0.61 | 64.70 | 15.23 | 3.71 | 4.66 | 0.52 | 5.74 | 2.39 | 51.72 | x |
| | 23 | DD, | 0.34 | 43% | 0.16 | 52.79 | 16.87 | 3.73 | 4.69 | 0.42 | 5.58 | 2.24 | 41.53 | Δ |
| | 24 | CRD, | 0.35 | 46% | 0.21 | 33.76 | 14.57 | 3.73 | 4.58 | 0.27 | 5.79 | 2.41 | 59.82 | x |
| | 25 | DD + CRD | 0.31 | 49% | 0.25 | 42.03 | 12.89 | 3.72 | 4.57 | 0.34 | 5.51 | 2.19 | 44.90 | Δ |
| | 26 | | 0.01 | 11% | 0.36 | 80.26 | 2.44 | 3.72 | 4.40 | 0.68 | 5.45 | 2.15 | 53.42 | x |
| | 27 | | 0.01 | 15% | 0.40 | 76.53 | 4.40 | 3.71 | 4.32 | 0.66 | 5.44 | 2.15 | 58.57 | x |
| | 28 | | 0.38 | 41% | 0.51 | 34.63 | 13.74 | 3.71 | 4.76 | 0.27 | 5.55 | 2.24 | 35.95 | □ |
| | 29 | | 0.40 | 45% | 0.56 | 52.88 | 16.55 | 3.73 | 4.34 | 0.45 | 5.43 | 2.12 | 56.20 | x |
| | 30 | | 0.41 | 41% | 0.60 | 48.77 | 17.11 | 3.73 | 4.50 | 0.40 | 5.67 | 2.31 | 58.76 | x |

Table 6 shows a drawing method of a copper plating-free solid wire assembly for gas-shielded arc welding which is wound around a spool, a drawing lubricant, a cast diameter reduction ratio, a worked surface ratio on a wire, a contact-tip contact index of a wire, and contact tip wear according to a ratio of the cross-sectional area of contact-tip through-hole and the cross-sectional area of a wire.

In Examples 1 to 14 of the invention, a cast diameter reduction ratio according to consumption of a wire was maintained at less than 0.55, a worked surface ratio in an arbitrary 10000 μm² area on a wire surface was maintained at 35-75%, a variation in worked surface ratio at four points measured along the wire's circumferential direction was maintained at less than 12, a contact-tip contact index of a wire was maintained at 0.28-0.65, and the cross-sectional area of a contact-tip through-hole after welding was maintained at less than twice the cross-sectional area of a wire. With these specifications, it was possible to obtain excellent contact tip wear resistance.

In Comparative Examples 15 to 17, 19, 20, 23 to 25, and 28, more than 40 wt % dry drawing lubricant, of which the particle size exceeds 500 μm, was used so that a variation in worked wire surface ratio deviated from the range of the invention. In Comparative Examples 15, 19, 20, 24, and 28, a worked wire surface ratio was so low that frictional resistance between a wire and a contact tip became large, increasing contact tip wear.

In Comparative Examples 18, 26, and 27, an amount of attached drawing lubricant was very small, and a worked surface ratio of a wire surface and a contact-tip contact index of a wire were very large. Thus, the feeding roller slipped during welding such that wire feeding was non-uniform and contact tip wear increased.

In Comparative Examples 21, 22, 29, and 30, an amount of attached drawing lubricant and a particle size were not appropriate, and a cast diameter reduction ratio according to wire consumption was so large that a difference in cast diameter became large depending on the position of a wire wound around a spool. Therefore, as welding progressed, contact tip wear was not uniform, and an increase in contact tip wear became large.

According to the invention, a cast diameter reduction ratio of a wire according to consumption of a welding wire wound around a spool, a worked surface ratio on the surface of a finalized wire, and a variation in worked surface ratio at four points measured along the wire's circumferential direction are properly maintained so that excellent welding wire contact-tip wear resistance can be achieved.

Further, a proper contact tip is selected in accordance with a contact-tip contact index during welding, and a contact tip is replaced at the proper time in accordance with a contact-tip replacement period according to a change in cross-sectional area of a contact-tip through-hole. Therefore, a contact tip replacement period can be extended and welding can be performed at an accurate welding position so that operational efficiency and productivity can be enhanced.

While few exemplary embodiments of the present invention have been shown and described, it will be appreciated by those skilled in the art that various changes may be made to these embodiments without departing from the spirit and scope of the invention as defined by the appended claims and their equivalents.

What is claimed is:

1. A copper plating-free solid wire assembly for gas-shielded arc welding comprising a spool, a contact tip, and a solid wire wound around the spool, wherein the wire comprises 0.03-0.10 wt % C, 0.45-1.05 wt % Si, 0.90-1.90 wt % Mn, less than 0.030 wt % P, less than 0.030 wt % S, and the remainder comprising Fe and impurities, and a cast diameter reduction ratio according to consumption of a wire, which is defined by the following equation, is equal to or less than 0.55:
$$Cast - diameter reduction ratio according to wire consumption = \frac{Cf - Co}{Cf}$$
where Cf represents the cast diameter of the wire wound around an upper portion of the spool, and Co represents the cast diameter of the wire wound around a lower portion of the spool.

2. The copper plating-free solid wire assembly for gas-shielded arc welding according to claim 1,
wherein a worked surface ratio in an arbitrary 10000 μm² area on the wire surface ranges from 35% to 75%.

3. The copper plating-free solid wire assembly for gas-shielded arc welding according to claim 2,
wherein a variation in worked surface ratio at four points measured along a circumferential direction of the wire is equal to or less than 12.

4. The copper plating-free solid wire assembly for gas-shielded arc welding according to claim 1,
wherein a contact-tip contact index of the wire, which is defined by the following equation, ranges from 0.28 to 0.65:
$$Contact - tip contact index of wire = \frac{WC}{PC} \times WS ,$$
where WC represents the circumference of the wire, PC represents the circumference of a wire through-hole of the contact tip, and WS represents a worked surface ratio on the wire surface.

5. A welding method using a copper plating-free solid wire assembly for gas-shielded arc welding, the method comprising:
selecting a contact tip having a contact-tip contact index of 0.28-0.65, the contact-tip contact index being a relation between a wire through-hole of the contact tip and a contact point of a worked surface on a wire surface;
continuously performing welding for one hour while repeating welding and stop until a wire wound around a spool is completely consumed;
calculating the cross-sectional area of the contact-tip through-hole during welding and measuring the amount of contact tip wear; and
when the cross-sectional area of the contact-tip through-hole exceeds twice the cross-sectional area of the wire, replacing the contact tip.
